(19) United States
(12) Patent Application Publication
(10) Pub. No.: US 2017/0093761 A1
(43) Pub. Date: Mar. 30, 2017

(54) METHOD AND DEVICE FOR SENDING ELECTRONIC SERVICE REMINDERS

(71) Applicant: Xiaomi Inc., Beijing (CN)

(72) Inventors: Daokuan Liu, Beijing (CN); Yao Tang, Beijing (CN); Shuai Liu, Beijing (CN); Chunhe Yang, Beijing (CN); Xinyan Xing, Beijing (CN)

(73) Assignee: Xiaomi Inc., Beijing (CN)

(21) Appl. No.: 15/266,154

(22) Filed: Sep. 15, 2016

(30) Foreign Application Priority Data
Sep. 30, 2015 (CN) 201510640419.8

(51) Int. Cl. H04L 12/58; H04L 12/26; H04L 29/08

(52) U.S. Cl. CPC H04L 51/04; H04L 67/26; H04L 43/06; H04L 67/10; H04W 4/008

(57) ABSTRACT

Methods and devices are disclosed for reminding inactive users of a cloud service about the cloud service. In one embodiment, a method for sending a reminder of a cloud service is disclosed. The method includes identifying an inactive user having a service account with the cloud service, determining whether the inactive user is potentially reachable electronically, and sending reminding information related to the cloud service to the inactive user when the inactive user is determined to be potentially reachable electronically.

### CROSS-REFERENCE TO RELATED APPLICATIONS

This application is based upon and claims priority to Chinese Patent Application 201510640419.8, filed Sep. 30, 2015, the entire contents of which are incorporated herein by reference.

### TECHNICAL FIELD

The present disclosure generally relates to field of computer technology, and more particularly, to a reminding method and device.

### BACKGROUND

Through a cloud service, a user of a mobile phone may, for example, back up and manage data in the mobile phone (such as contacts, short messages, call log, email messages, photos, and notes) in a cloud server. Because the mobile phone is normally connected to the cloud server at all times, the backup service may be automatically scheduled at a frequency that may be nearly real-time. Such a cloud service thus allows for speedy and accurate recovery of contents and software status and data of the mobile phone in case that the mobile phone is replaced or is lost. A user of mobile phones, however, may be accustomed to a traditional backup and recovery mechanism based on a local personal computer. He/she may not utilize the functions provided by the cloud service even though he/she may have been provided a cloud account with the purchase of the mobile phone. Because the mobile phone and the local personal computer may not be connected at all times, the traditional backup mechanism may not be timely and thus data loss for the user may occur when the mobile phone fails or is lost. Such a user may be referred to as an “inactive user” of the backup cloud service hereinafter.

### SUMMARY

The present disclosure provides methods and devices for sending electronic service reminders to inactive user of a cloud service. This summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In one embodiment, a method for sending a reminder of a cloud service is disclosed. The method includes identifying an inactive user having a service account with the cloud service; determining whether the inactive user is potentially reachable electronically; and sending reminding information related to the cloud service to the inactive user when the inactive user is determined to be potentially reachable electronically.

In another embodiment, a server is disclosed. The server includes a processor; and a memory for storing instructions executable by the processor, wherein the processor is configured to: identify an inactive user having a service account with a cloud service; determine whether the inactive user is potentially reachable electronically; and send reminding information related to the cloud service to the inactive user when the inactive user is determined to be potentially reachable electronically.

In yet another embodiment, a non-transitory computer-readable storage medium comprising instructions is disclosed. The instructions, when executable by a processor in a server of a cloud service, cause the server to identify an inactive user having a service account with the cloud service; determine whether the inactive user is potentially reachable electronically; and send reminding information related to the cloud service to the inactive user when the inactive user is determined to be potentially reachable electronically.

### BRIEF DESCRIPTION OF THE DRAWINGS

The accompanying drawings, which are incorporated in and constitute a part of this specification, illustrate embodiments consistent with the invention and, together with the description, serve to explain the principles of the invention.

FIG. 1A illustrates an application context for the embodiments of the present disclosure.

FIG. 1B is an illustrative flow chart for sending a reminder to an inactive user of a cloud service according to an embodiment of the present disclosure.

FIG. 2 is a flow chart of a specific implementing step of step S102 in FIG. 1B.

FIG. 3 is a flow chart of a specific implementing step of step S103 in FIG. 1B.

FIG. 4 is a block diagram of a device for sending a reminder to an inactive user of a cloud service according to an embodiment of the present disclosure.

FIG. 5 is a block diagram for a specific implementation of the inactive user judging module 402 of FIG. 4.

FIG. 6 is a block diagram for a specific implementation of the reminding information sending module 403 of FIG. 4.

FIG. 7 is a block diagram for a specific implementation of the inactive user information acquiring module 601 of FIG. 6.

FIG. 8 is a block diagram of a terminal device according to an embodiment of the present disclosure.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of apparatuses and methods consistent with aspects related to the invention as recited in the appended claims.

Terms used in the disclosure are only for purpose of describing particular embodiments, and are not intended to be limiting. The terms “a”, “said” and “the” used in singular form in the disclosure and appended claims are intended to include a plural form, unless the context explicitly indicates otherwise. It should be understood that the term “and/or” used in the description means and includes any or all combinations of one or more associated and listed terms.

It should be understood that, although the disclosure may use terms such as “first”, “second” and “third” to describe various information, the information should not be limited herein. These terms are only used to distinguish information of the same type from each other. For example, first information may also be referred to as second information, and the second information may also be referred to as the first information, without departing from the scope of the disclosure. Based on context, the word “if” used herein may be interpreted as “when”, or “while”, or “in response to a determination”.

By way of introduction, an inactive user of a particular cloud service for a mobile device having a cloud service account may be reminded of the existence and advantage of the cloud service such that he/she may become aware of the service and begin to use it, resulting in improved overall user experience. A cloud service provider may provide a set of cloud services to the users of mobile devices. A user may user some services but not the others. A user thus may be active as to some cloud services and inactive as to the other cloud services. For example, the user may actively use a cloud based short message communication function but may not use the cloud backup service. This disclosure describes methods and devices for identifying inactive users of a certain cloud service and sending out reminders of the cloud service to them electronically. Although this disclosure is based on the exemplary cloud service related to mobile phones, the principles described below and the claims are not so limited and apply to other context involving other types of mobile devices and cloud services.

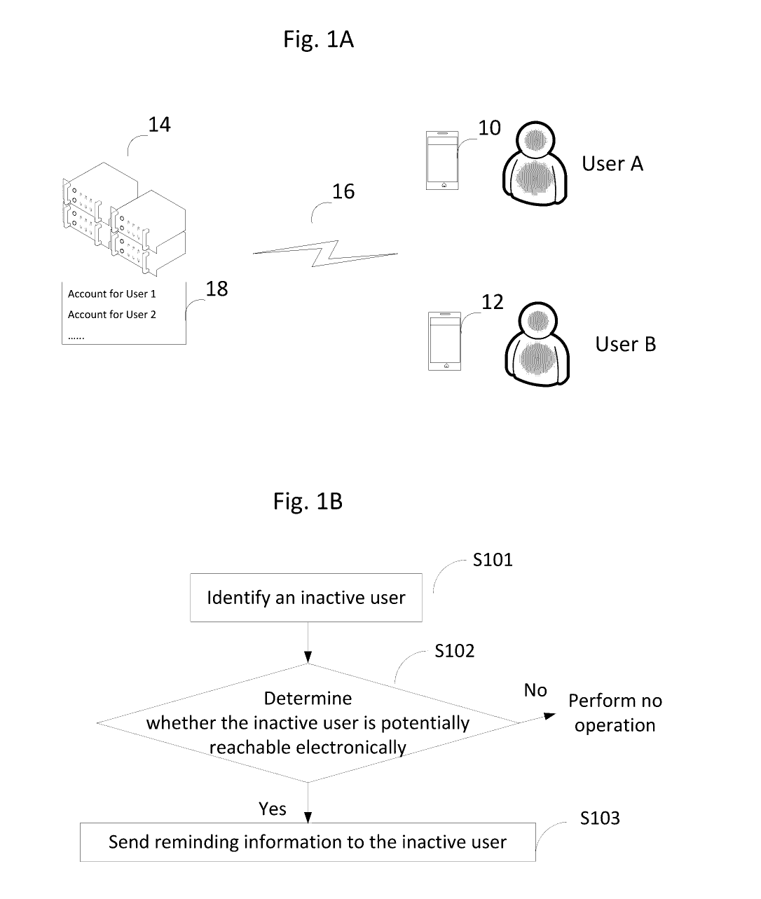

FIG. 1A illustrates an exemplary use context for the methods and devices according to embodiments of the present disclosure. Variety of cloud services for the mobile phones 10 and 12 may be provided by a cloud server 14. The mobile phones 10 and 12 may be in communication with the cloud server 14 via communication network 16. The communication network 16 may be based on various wired and wireless technologies and any combination thereof. The servers may be a single server or a group of distributed servers combined to provide all related cloud services. Alternatively, each cloud service may be separately provided by a single or group of distributed servers. The server may be managed by the manufacturer of the mobile phones or may be alternatively managed by the provider of the operating system of the mobile phones or may be provided by third party cloud service providers. Examples of integrated cloud services for mobile phones and other mobile devices include but are not limited to iCloud of Apple and G Cloud of Google. Each of these examples provides various cloud services to the users. The cloud server 14 may maintain user cloud accounts, such as an account for User A (user of the mobile phone 10) and an account for User B (user of the mobile phone 12), as illustrated by 18 of FIG. 1A. The accounts may be assigned to users when the mobile phones are purchased and set up. In addition to a backup service, the cloud server may further provide other communication services such as short messaging between its users and keeping track of those communication activities in terms of parties involved and manner of communications, e.g., short messages, emails and the like. As an example, User A may be an inactive user for e.g., the cloud backup service, in that User A may either be unaware of the existence of the cloud backup service or may be ignorant of the convenience of the cloud backup service and choose not to use it. User B, on the other hand, may be more technologically savvy and uses the cloud back service on a regular basis and is thus an active user of the cloud backup service.

FIG. 1B is a flow chart of a method for sending reminders of a particular cloud service to an inactive user of that cloud service according to an exemplary embodiment of the present disclosure. In step S101, an inactive user of the cloud service is identified. For example, the server may monitor usage activity and status of a user of a cloud backup service provided by the server. If the user does not use the cloud backup service for a predefined period of time, the user may be identified as an inactive user of the cloud backup service. In step S102, the cloud server determines whether the identified inactive user is potentially reachable electronically. In other words, the server determines whether the inactive user may potentially have access to electronic communication to be sent to him/her about the particular cloud service. When the identified inactive user of the particular cloud service, e.g., the cloud backup service, is determined to be potentially reachable electronically, the server, in step S103, sends reminding information about the cloud service to the identified inactive user. The reminding information may be of any type. For instance, the reminding information may be a notice that reminds the user that there is still data stored in the cloud server currently and the function of the cloud service may be utilized for the convenience of the inactive user. The inactive user may thus be informed of the particular unutilized cloud service and may as a result begin to actively use the cloud service to his/her convenience and improved user experience.

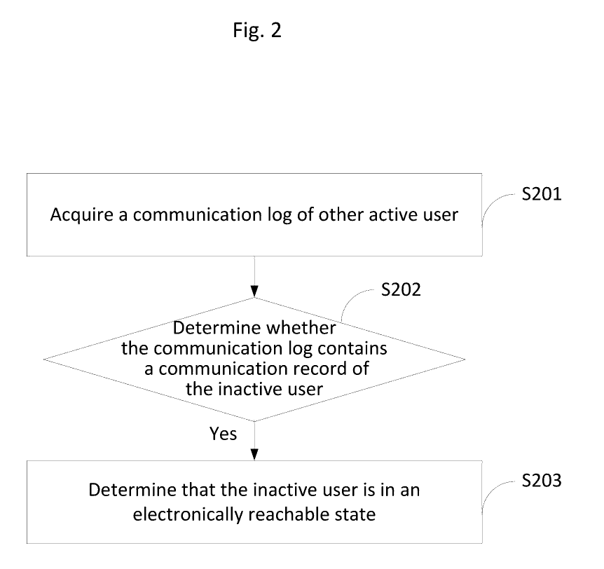

One specific implementation of step S102 of determining whether an inactive user is in an electronically reachable state is illustrated by the flow chart in FIG. 2. In step S201, communication log of other active users is acquired. The communication log may be part of the information maintained by the cloud server when providing other types of cloud services (such as cloud services based short message and email services) to the users. The log may be maintained in a database in the server or a separate database in communication with the server. The server may acquire the log from the data base either locally or from other servers. In step S202, the cloud server determines whether the communication log contains a communication record between at least one other user with the inactive user. When such a record is found, the server determines, in step S203, that the inactive user has been in active communications with others and is thus in an electronically reachable state. The communication log above may generally include a call log, a short message log, or an electronic mail log. Correspondingly, the communication record may be a call record, a short message record, or an electronic mail record between the inactive user of the particular cloud service and other users.

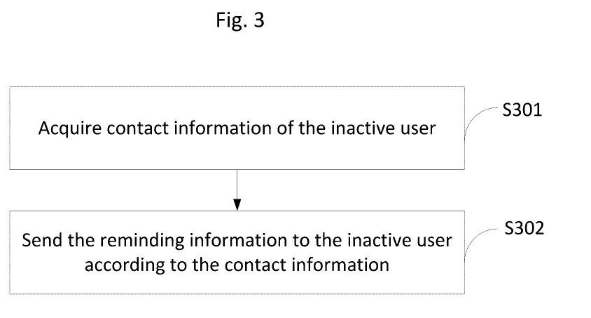

One particular implementation of the step S103 of FIG. 1B of sending reminding information to the inactive user is illustrated by the flow chart shown in FIG. 3. In step 301, contact information of the inactive user is acquired by the cloud server. The manner of acquiring the contact information of the inactive user may include: reading contact information provided during registration of the inactive user for the particular cloud service (not used by the user) or other cloud services; and reading contact information of the inactive user from the communication record between the other users and the inactive user discussed above. For example, the contact information of the inactive user may be acquired based on signup information provided when the user registered for the cloud service. Generally, when accepting a registration from a user, the cloud server may prompt the user to fill in some registration information including contact information including but not limited to phone number information, email address information, instant messaging account information (such as Tencent QQ account), and personal account information generated by registering with a social media platform by the user (such as a WeChat ID). Such contact information may be accessed and used for sending reminding information to the inactive user. Such contact information, however, may be out-of-date and invalid. Thus, the contact information obtained from communication records between the inactive user and other users may be more up-to-date and may provide a preferred manner for sending the reminding information.

After acquiring the contact information of the inactive user of cloud service, the cloud server may in step S302 electronically send the reminding information to the inactive user of cloud service according to the contact information. In particular, when the acquired contact information is a phone number, a short message of reminder may be sent to this phone number. Alternatively, the cloud customer service may dial the phone number to remind the user. When the acquired contact information is am electronic mail address, a reminding email may be sent to the electronic mailbox of the inactive user. When the acquired contact information is an instant messaging account information of the inactive user, an instant reminding message may be sent to the account. When the acquired contact information is a personal account information generated by registering with a social media platform by the inactive user, a reminding message may be sent to the user's personal account in the corresponding social media platform. The reminding information may be sent to the inactive user via multiple manners discussed above when multiple types of contact information are identified.

The following provides an exemplary application of the embodiments disclosed above. User A of FIG. 1A may registers for a cloud backup service on the cloud server. The cloud server may monitor the usage of the cloud backup service by User A, and when finding that User A does not use relevant function (backup service) of the cloud service within a predefined period of time, the cloud server determines that the User A is an inactive user of the cloud backup service. In order to remind User A to use the service, the cloud server may acquire the contact information of User A. In one manner, the cloud server acquires and scans the communication log of the User A as well as other users (such as User B). The server determines whether the communication log contains a communication record between User A and e.g., User B. If such a communication record is found, the contract information contained in the communication record may be deemed current and valid and may be exacted from the communication record as the current contact information for User A. In another alternative manner, when the cloud server does not find any communication record between the User A and other users, the contact information contained in the registration information provided by the user when registering for the cloud service may be extracted as current contact information for User A. The cloud server may then send the reminding information to the User A according to the extracted contact information for reminding User A of the cloud backup service.

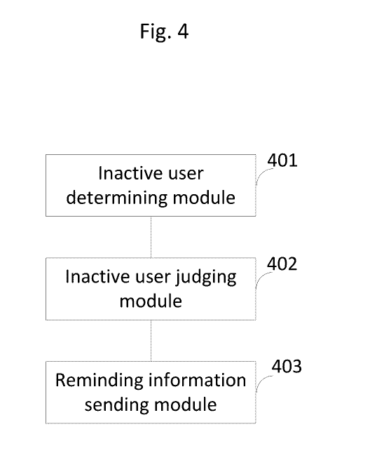

Corresponding to the above method embodiments, the present disclosure also provides a reminding device which may be applied in a server. FIG. 4 is one specific embodiment of the device, and the device may particularly include: an inactive user determining module 401, an inactive user judging module 402, and a reminding information sending module 403.

The inactive user determining module 401 is configured to identify an inactive user. The inactive user judging module 402 is configured to determine whether the inactive user is potentially in an electronically reachable state. The reminding information sending module 403 is configured to send reminding information to the inactive user electronically when it is determined that the inactive user is potentially in an electronically reachable state.

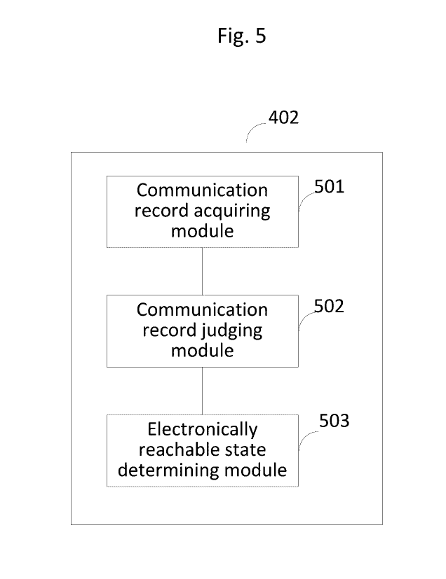

FIG. 5 illustrates a specific implementation of the inactive user judging module 402 of FIG. 4. The inactive user judging module may 402 include a communication record acquiring unit 501 configured to acquire a communication log of the inactive user and other users, a communication record judging unit 502 configured to determine whether the communication log contains a communication record between the inactive user and another user, and an electronically reachable state determining unit 503 for determining that the user is electronically reachable if such a communication record exists.

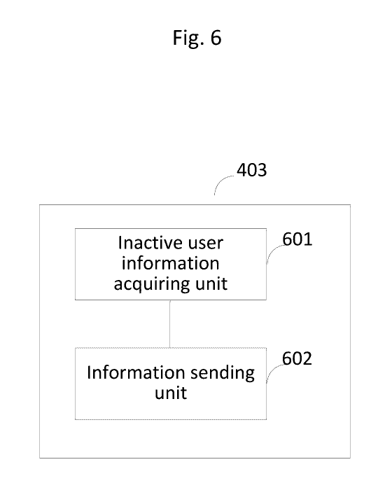

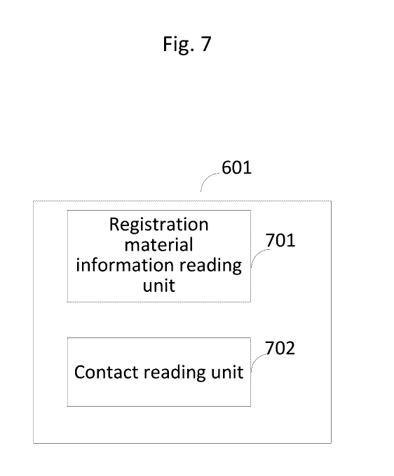

FIG. 6 illustrates a specific implementation of the reminding information sending module 403 of FIG. 4. The reminding information sending module 403 may include an inactive user information acquiring unit 601 configured to acquire contact information of the inactive user, and an information sending unit 602 configured to send the reminding information to the inactive user according to the contact information. FIG. 7 shows a specific implementation of the inactive user information acquiring unit 601. The inactive user information acquiring unit may include a registration material information reading unit 701 configured to read contact information provided during registration of the inactive user, and a contact reading unit 702 configured to read contact information of the inactive user in the communication record of the other active user with the inactive user.

Correspondingly, the present disclosure also provides an embodiment of a server. The server may include a processor; and a memory for storing instructions executable by the processor; wherein the processor is configured to perform the methods described above.

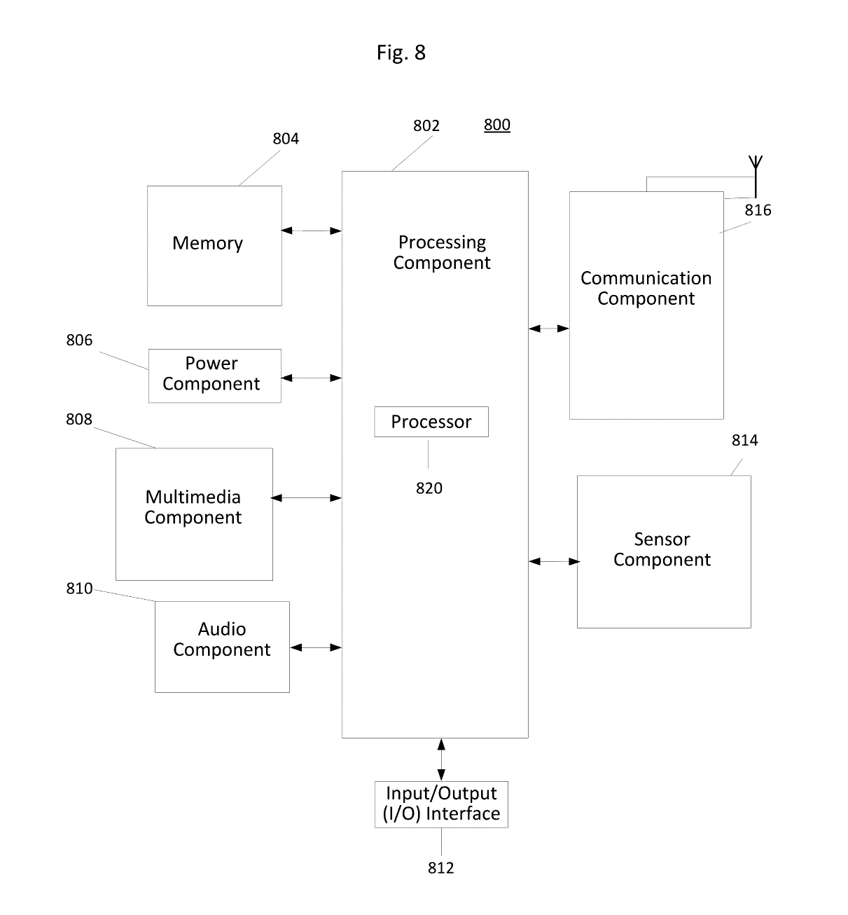

FIG. 8 is a block diagram of a terminal device to access a wireless LAN, according to an exemplary embodiment. For example, the device 800 may be a mobile phone, a computer, a digital broadcast terminal, a messaging device, a gaming console, a tablet, a medical device, exercise equipment, a personal digital assistant, and the like.

Referring to FIG. 8, the device 800 may include one or more of the following components: a processing component 802, a memory 804, a power component 806, a multimedia component 808, an audio component 810, an input/output (I/O) interface 812, a sensor component 814, and a communication component 816.

The processing component 802 controls overall operations of the device 800, such as the operations associated with display, telephone calls, data communications, camera operations, and recording operations. The processing component 802 may include one or more processors 820 to execute instructions to perform all or part of the steps in the above described methods. Moreover, the processing component 802 may include one or more modules which facilitate the interaction between the processing component 802 and other components. For instance, the processing component 802 may include a multimedia module to facilitate the interaction between the multimedia component 808 and the processing component 802.

The memory 804 is configured to store various types of data to support the operation of the device 800. Examples of such data include instructions for any applications or methods operated on the device 800, contact data, phonebook data, messages, pictures, video, etc. The memory 804 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 806 provides power to various components of the device 800. The power component 806 may include a power management system, one or more power sources, and any other components associated with the generation, management, and distribution of power in the device 800.

The multimedia component 808 includes a display screen providing an output interface between the device 800 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 808 includes a front camera and/or a rear camera. The front camera and the rear camera may receive an external multimedia datum while the device 800 is in an operation mode, such as a photographing mode or a video mode. Each of the front camera and the rear camera may be a fixed optical lens system or have focus and optical zoom capability.

The audio component 810 is configured to output and/or input audio signals. For example, the audio component 810 includes a microphone (“MIC”) configured to receive an external audio signal when the device 800 is in an operation mode, such as a call mode, a recording mode, and a voice recognition mode. The received audio signal may be further stored in the memory 804 or transmitted via the communication component 816. In some embodiments, the audio component 810 further includes a speaker to output audio signals.

The I/O interface 812 provides an interface between the processing component 802 and peripheral interface modules, such as a keyboard, a click wheel, buttons, and the like. The buttons may include, but are not limited to, a home button, a volume button, a starting button, and a locking button.

The sensor component 814 includes one or more sensors to provide status assessments of various aspects of the device 800. For instance, the sensor component 814 may detect an open/closed status of the device 800, relative positioning of components, e.g., the display and the keypad, of the device 800, a change in position of the device 800 or a component of the device 800, a presence or absence of user contact with the device 800, an orientation or an acceleration/deceleration of the device 800, and a change in temperature of the device 800. The sensor component 814 may include a proximity sensor configured to detect the presence of nearby objects without any physical contact. The sensor component 814 may also include a light sensor, such as a CMOS or CCD image sensor, for use in imaging applications. In some embodiments, the sensor component 814 may also include an accelerometer sensor, a gyroscope sensor, a magnetic sensor, a pressure sensor, or a temperature sensor or thermometer.

The communication component 816 is configured to facilitate communication, wired or wirelessly, between the device 800 and other devices. The device 800 can access a wireless network based on a communication standard, such as WiFi, 2G, 3G, LTE, or 4G cellular technologies, or a combination thereof. In one exemplary embodiment, the communication component 816 receives a broadcast signal or broadcast associated information from an external broadcast management system via a broadcast channel In one exemplary embodiment, the communication component 816 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In exemplary embodiments, the device 800 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In exemplary embodiments, there is also provided a non-transitory computer-readable storage medium including instructions, such as included in the memory 804, executable by the processor 820 in the device 800, for performing the above-described methods. For example, the non-transitory computer-readable storage medium may be a ROM, a RAM, a CD-ROM, a magnetic tape, a floppy disc, an optical data storage device, and the like.

Each module or unit discussed above for FIG. 4-7, such as the inactive user determining module, the inactive user judging module, the reminding information sending module, the communication record acquiring module, the communication record judging module, the electronically reachable state determining module, the inactive user information acquiring unit, the information sending unit, the registration material information reading unit, the contact reading unit may take the form of a packaged functional hardware unit designed for use with other components, a portion of a program code (e.g., software or firmware) executable by the processor 820 or the processing circuitry that usually performs a particular function of related functions, or a self-contained hardware or software component that interfaces with a larger system, for example.

The illustrations of the embodiments described herein are intended to provide a general understanding of the structure of the various embodiments. The illustrations are not intended to serve as a complete description of all of the elements and features of apparatus and systems that utilize the structures or methods described herein. Other embodiments of the disclosure will be apparent to those skilled in the art from consideration of the specification and practice of the embodiments disclosed herein. This application is intended to cover any variations, uses, or adaptations of the disclosure following the general principles thereof and including such departures from the present disclosure as come within known or customary practice in the art. It is intended that the specification and examples are considered as exemplary only, with a true scope and spirit of the invention being indicated by the following claims in addition to the disclosure.

It will be appreciated that the present invention is not limited to the exact construction that has been described above and illustrated in the accompanying drawings, and that various modifications and changes can be made without departing from the scope thereof. It is intended that the scope of the invention only be limited by the appended claims.

What is claimed is:

1. A method for sending a reminder of a cloud service, comprising:
identifying an inactive user having a service account with the cloud service;
determining whether the inactive user is potentially reachable electronically; and
sending reminding information related to the cloud service to the inactive user when the inactive user is determined to be potentially reachable electronically.

2. The method of claim 1, wherein determining whether the inactive user is potentially reachable electronically comprises:
when the inactive user is identified, acquiring a communication log of at least one active user of the cloud service, the communication log corresponding to a predetermined duration of time preceding identifying the inactive user; and
determining that the inactive user is potentially reachable electronically when the communication log contains a communication record with the inactive user.

3. The method of claim 2, wherein the communication log comprises at least one of a call log, a short message log, or an electronic mail log.

4. The method of claim 1, wherein sending the reminding information related to the cloud service to the inactive user comprises:
acquiring electronic contact information of the inactive user; and
sending the reminding information related to the cloud service to the inactive user according to the electronic contact information.

5. The method of claim 4, wherein the electronic contact information of the inactive user comprises at least one of:
electronic contact information provided by the inactive user during registration of the inactive user with the cloud service; or
electronic contact information of the inactive user contained in a communication record of other active users with the inactive user.

6. The method of claim 4, wherein the electronic contact information comprises information regarding at least one of a phone number, an email address, an instant messaging account, or a personal account generated by registering with a social media platform by the inactive user.

7. A server, comprising:
a processor; and
a memory for storing instructions executable by the processor,
wherein the processor is configured to:
identify an inactive user having a service account with a cloud service;
determine whether the inactive user is potentially reachable electronically; and
send reminding information related to the cloud service to the inactive user when the inactive user is determined to be potentially reachable electronically.

8. The server of claim 7, wherein to determine whether the inactive user is potentially reachable electronically, the processor is configured to cause the server to:
acquire a communication log of at least one other active user of the cloud service within a predetermined duration of time preceding identifying the inactive user; and
determining that the inactive user is potentially reachable electronically when the communication log contains a communication record with the inactive user.

9. The server of claim 8, wherein the communication record comprises at least one of a call log, a short message log, or an electronic mail log.

10. The server of claim 7, wherein to send the reminding information related to the cloud service to the inactive user, the processor is configured to cause the server to:
acquire electronic contact information of the inactive user; and
send the reminding information related to the cloud service to the inactive user according to the electronic contact information.

11. The server of claim 10, wherein the electronic contact information of the inactive user comprises at least one of:
electronic contact information provided by the inactive user during registration of the inactive user with the cloud service; or
electronic contact information of the inactive user contained in a communication record of other active users with the inactive user.

12. The server of claim 10, wherein the electronic contact information comprises at least one of a phone number, an email address, an instant messaging account, or a personal account information generated by registering with a social media platform by the inactive user.

13. A non-transitory computer-readable storage medium comprising instructions, when executed by a processor in a server of a cloud service, causing the server to:
identify an inactive user having a service account with the cloud service;
determine whether the inactive user is potentially reachable electronically; and
send reminding information related to the cloud service to the inactive user when the inactive user is determined to be potentially reachable electronically.
